(19) United States
(12) Patent Application Publication
(10) Pub. No.: US 2008/0160204 A1
(43) Pub. Date: Jul. 3, 2008

(54) Spontaneous copper seed deposition process for metal interconnects

(76) Inventors: Adrien R. Lavoie, Beaverton, OR (US); James M. Blackwell, Portland, OR (US); Darryl J. Morrison, Calgary (CA); Manish Sharma, Ithaca, NY (US)

Correspondence Address: INTEL CORPORATION;c/o INTELLEVATE, LLC, P.O. BOX 52050, MINNEAPOLIS, MN, 55402, US

(21) Appl. No.: 11/648,006

(22) Filed: Dec. 28, 2006

(51) Int. Cl. B05D 1/18; B05C 3/00

(52) U.S. Cl. 427/431; 118/400

(57) ABSTRACT

A method for depositing a copper seed layer onto a semiconductor substrate comprises applying a SCuD plating bath onto a surface of a substrate, rinsing the surface with an organic solvent, applying a co-reactant bath to the surface, and again rinsing the surface with an organic solvent. The SCuD plating bath is non-aqueous and comprises a copper precursor that is dissolved into an organic solvent. The co-reactant bath is also non-aqueous and comprises a co-reactant dissolved into an organic solvent. The SCuD plating bath may be heated before being applied to the substrate surface.

### BACKGROUND

In the manufacture of integrated circuits, copper interconnects are generally formed on a semiconductor substrate using a copper dual damascene process. Such a process begins with a trench being etched into a dielectric layer and filled with a barrier layer, an adhesion layer, and a seed layer. A physical vapor deposition (PVD) process, such as a sputtering process, may be used to deposit a tantalum nitride (TaN) barrier layer and a tantalum (Ta) or ruthenium (Ru) adhesion layer (i.e., a TaN/Ta or TaN/Ru stack) into the trench. The TaN barrier layer prevents copper from diffusing into the underlying dielectric layer. The Ta or Ru adhesion layer is required because the subsequently deposited metals do not readily nucleate on the TaN barrier layer. This may be followed by a PVD sputter process to deposit a copper seed layer into the trench. An electroplating process is then used to fill the trench with copper metal to form the interconnect.

As device dimensions scale down, the aspect ratio of the trench becomes more aggressive as the trench becomes narrower. This gives rise to issues such as trench overhang during the copper seed deposition, leading to pinched-off trench openings during plating and inadequate gapfill. Additionally, as trenches decrease in size, the ratio of barrier metal to copper metal in the overall interconnect structure increases, thereby increasing the electrical line resistance and RC delay of the interconnect.

One approach to addressing these issues is to reduce the thickness of the TaN/Ta or TaN/Ru stack, which widens the available gap for subsequent metallization and increases the final copper volume fraction. Unfortunately, this is often limited by the non-conformal characteristic of PVD deposition techniques. Accordingly, alternative techniques for reducing the thickness of the barrier and adhesion layer are needed.

### BRIEF DESCRIPTION OF THE DRAWINGS

FIGS. 1A to 1B illustrate a conventional damascene process for forming metal interconnects.

FIG. 2 is a method for carrying out a spontaneous copper deposition process in accordance with one implementation of the invention.

FIG. 3 is another method for carrying out a spontaneous copper deposition process in accordance with one implementation of the invention.

FIG. 4 is an alternate way to carry out the method of FIG. 3.

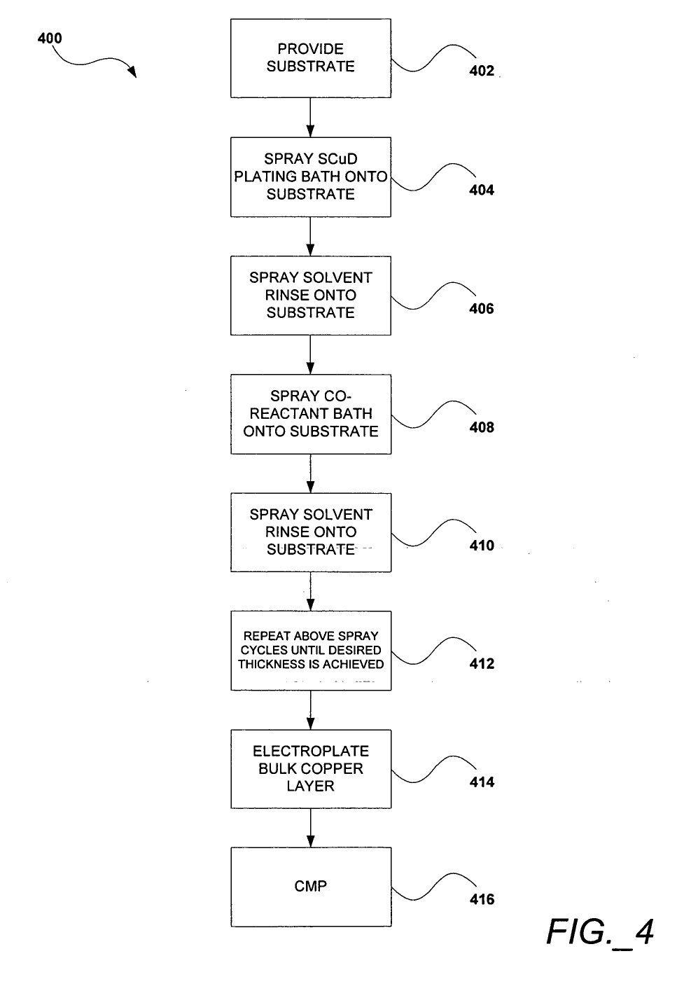

### DETAILED DESCRIPTION

Described herein are systems and methods of fabricating a metal interconnect for integrated circuit applications using a novel spontaneous copper deposition process that produces relatively thinner copper seed layers. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

Implementations of the invention provide methods for fabricating thin copper seed layers relative to conventionally formed copper seed layers. By fabricating a relatively thin copper seed layer, problematic issues such as trench overhang, pinching off of trench openings, and void formation may be reduced or avoided. In implementations of the invention, a spontaneous copper deposition process is used to generate the thin copper seed layer.

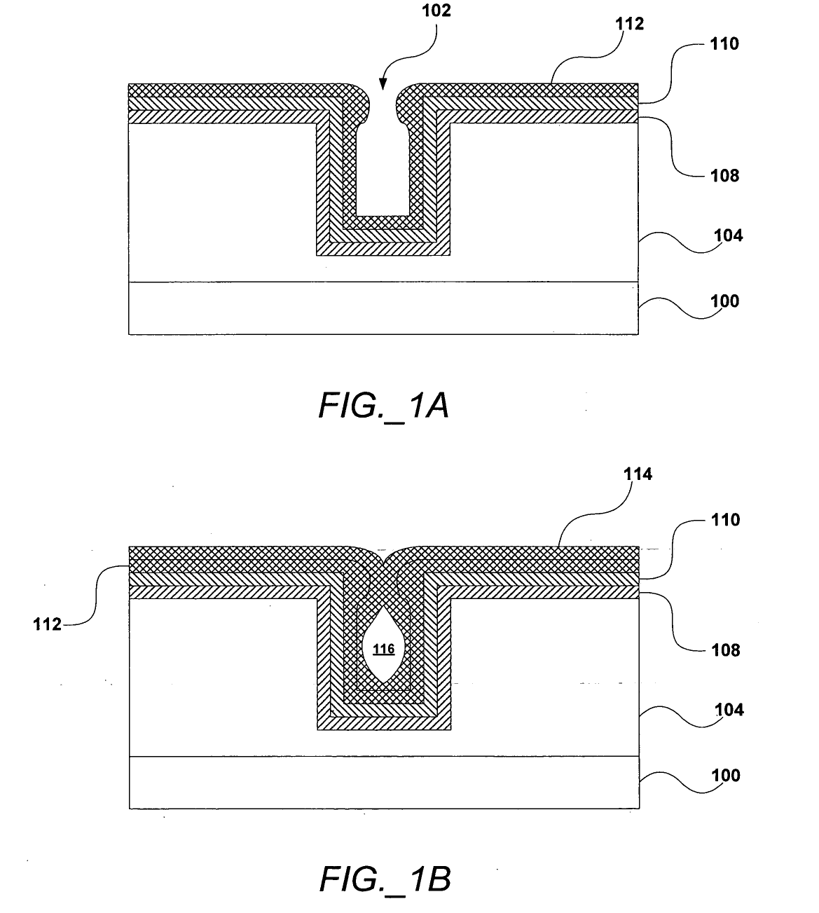

For reference, FIGS. 1A to 1B illustrate a conventional damascene process for fabricating copper interconnects on a semiconductor wafer. FIG. 1A illustrates a substrate 100, such as a semiconductor wafer, that includes a trench 102 that has been etched into a dielectric layer 104. A conventional barrier layer 108 and adhesion layer 110 are conformally deposited on the dielectric layer 104 and within the trench 102. The barrier layer 108 is generally formed from tantalum nitride (TaN) and prevents copper metal from diffusing into the dielectric layer 104. The adhesion layer 110 is generally formed from tantalum (Ta) or ruthenium (Ru) and enables copper metal to become deposited onto the barrier layer 108.

After the adhesion layer 110 is formed, the conventional damascene process uses two independent deposition processes to fill the trench 102 with copper metal. The first deposition process is a PVD process that forms a non-conformal copper seed layer 112, which is shown in FIG. 1A and enables a subsequent plating process to fill the trench 102 with copper metal. As shown, the PVD process may cause some trench overhang to occur in the copper seed layer 112 that narrows the width of the trench 102. The second deposition process is a plating process, such as an electroplating (EP) or electroless plating (EL) process, that deposits a bulk copper layer 114 to fill the trench 102.

FIG. 1B illustrates the trench 102 after an EP or EL copper deposition process has been carried out. Due to the narrow width of the trench 102, issues such as trench overhang and pinching off of the trench opening occur that lead to defects in the plating step. As shown in FIG. 1B, such defects include a void 116 that will now appear in the final metal interconnect after the excess metal disposed outside of the trench 102 is removed during a subsequent planarization step. Furthermore, a substantial portion of the final copper interconnect comprises Ta and/or Ru from the adhesion layer 110 and the barrier layer 108, which decreases the percentage of copper in the final interconnect and increases the RC delay.

To improve upon conventional processes for fabricating metal interconnects, implementations of the invention use a novel spontaneous copper deposition process (herein referred to as a “SCuD” process) that has a relatively high deposition rate and enables the formation of smooth copper seed layers that are relatively thin and have low electrical resistance. The copper seed layers formed using the SCuD process also have high copper purity with reduced oxidation.

The SCuD process employs a novel plating bath that deposits copper metal onto the surface of a substrate. Unlike conventional plating baths used in electroplating processes and electroless plating processes, the SCuD plating bath described herein is not an aqueous solution (i.e., the plating bath contains no water). Rather, in accordance with implementations of the invention, the SCuD plating bath uses a non-aqueous, organic solvent such as toluene to provide the foundation of the plating bath. By eliminating water from the plating bath, oxygen is inhibited from contacting the deposited copper metal and oxidation at the copper surface is substantially reduced or eliminated. Less oxidation allows the SCuD formed copper seed layer to be thinner and less resistive than conventionally formed copper seed layers.

The SCuD process may be autocatalytic. It has been shown that copper deposited using a SCuD process carried out in accordance with an implementation of the invention tends to selectively deposit on metals and not on insulators. This is similar to standard electroless plating processes for copper. The SCuD process therefore does not require an electrical current so it does not suffer from terminal effects that are encountered in electroplating processes. Furthermore, the SCuD plating bath is a low temperature plating bath, which substantially reduces or eliminates copper metal agglomeration.

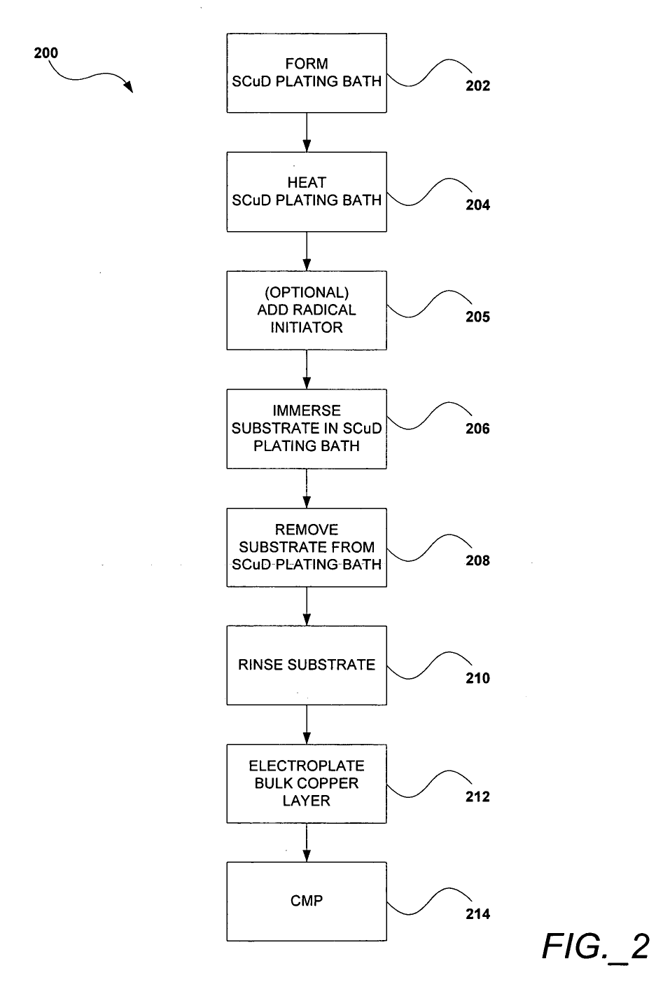

FIG. 2 is a method 200 for carrying out a SCuD process in accordance with one implementation of the invention. First, a SCuD plating bath is formed by providing an organic solvent and dissolving a copper precursor into the organic solvent (202). In various implementations of the invention, the organic solvent may be toluene. In other implementations, alternate organic solvents may be used, including but not limited to acetone, acrylamide, benzene, carbon disulfide, ethylene oxide, n-hexane, hydrogen sulfide, methane, methyl mercaptan, methyl-N-butyl ketone, methylene chloride, organochlorine, organophosphates, perchloroethene, styrene, methyl chloroform, trichloroethene, vinyl chloride, mesitylene, hexanes, decane, octane, nonane, diethylether, tetrahydrofuran and xylene.

The copper precursor that is dissolved into the organic solvent may be chosen from among a variety of potential copper precursors. A list of potential copper precursors that may be used in implementations of the invention is provided below. The amount of copper precursor added to the organic solvent will vary based on the needs of a specific interconnect fabrication process, but in some implementations of the invention, the copper precursor concentration in the organic solvent may range between around 0.001 to 0.1 Molar (M).

The SCuD plating bath is then heated to a desired process temperature (204). In implementations of the invention, this process temperature may range from around 25° C. to around 100° C. At this temperature, it is believed that the copper precursor spontaneously decomposes at a kinetically adequate rate and/or undergoes a disproportionation mechanism. This results in the production of metallic copper (Cu(0)), thereby enabling a spontaneous deposition of continuous, uniform and thin copper metal to occur on a substrate.

A semiconductor substrate is immersed into the heated SCuD plating bath (206). In implementations of the invention, the substrate may be immersed for a time duration that ranges from 2 seconds to 3600 seconds. In some implementations of the invention, the plating bath may be agitated during all or part of the time that the substrate remains immersed.

The semiconductor substrate may be formed using a bulk silicon or a silicon-on-insulator substructure. In other implementations, the substrate may be formed using alternate materials, which may or may not be combined with silicon, that include but are not limited to germanium, indium antimonide, lead telluride, indium arsenide, indium phosphide, gallium arsenide, gallium antimonide, or other Group Ill-V materials. Although a few examples of materials from which the semiconductor substrate may be formed are described here, any material that may serve as a foundation upon which a semiconductor device may be built falls within the spirit and scope of the present invention.

The substrate has at least one dielectric layer deposited on its surface. The dielectric layer may be formed using materials known for the applicability in dielectric layers for integrated circuit structures, such as low-k dielectric materials. Such dielectric materials include, but are not limited to, silicon dioxide (SiO₂), carbon doped oxide (CDO), silicon nitride, organic polymers such as perfluorocyclobutane or polytetrafluoroethylene, fluorosilicate glass (FSG), and organosilicates such as silsesquioxane, siloxane, or organosilicate glass. The dielectric layer may include pores or other voids to further reduce its dielectric constant. The dielectric layer may include one or more trenches and/or vias within which the barrier and copper seed containing layer will be deposited and the metal interconnect will be formed. The trenches and/or vias may be patterned using conventional wet or dry etch techniques that are known in the art.

During this immersion, a copper seed layer becomes deposited on the barrier which is on top of the dielectric layer and within the trench. The deposition rate of copper metal during the SCuD process is dependent upon a variety of factors, including but not necessarily limited to the specific copper precursor, precursor concentration (i.e., the molarity of the copper precursor dissolved in solution), the substrate material, the plating bath temperature, solution agitation, and the reaction time to name a few (it is recognized that other variables will exist). For instance, as the copper precursor molarity is increased, the deposition rate of the SCuD process will generally increase. Furthermore, depending on the time duration of the immersion, the thickness of the copper seed layer may range from 3nm to 50nm. In accordance with the invention, the copper seed layer that is formed has a high copper purity with low electrical resistance.

Once the copper seed layer has reached a desired thickness, the semiconductor substrate is removed from the SCuD plating bath (208). In some implementations, the substrate may then be rinsed with an organic solvent, such as the solvent used to form the SCuD plating bath including though not limited to mesitylene, hexanes, decane, octane, nonane, diethylether, tetrahydrofuran, or an aqueous solvent (210). The deposited seed may optionally be rinsed with water.

In an alternate implementation of the invention, a radical initiator may be added to the plating bath prior to immersion of the semiconductor substrate (205). The free-radicals produced by the radical initiator mediate the spontaneous copper deposition process. In implementations of the invention, radical initiators that may be added to the SCuD plating bath include, but are not limited to, 2,2,6,6-tetramethylpiperidine-N-oxyl (TEMPO), benzoyl peroxide, tert-butyl peroxide, and metal and main group radicals. In various implementations, the concentration of radical initiator in the organic solvent may range from 0.001 M to 0.1 M.

Following the formation of the copper seed layer using the SCuD process, the substrate may be transferred to a reactor containing a plating bath and a plating process may be carried out to deposit a metal layer, such as a bulk copper layer, over the copper seed layer (212). The copper layer fills the trench to form the copper interconnect. The copper metal enters the trench where, due to the relatively large width of the trench enabled by the thin copper seed layer, issues such as void formation due to overhang are reduced or eliminated. In some implementations, the plating bath is an electroplating bath and the plating process is an electroplating process in which the copper metal nucleates directly on the copper seed layer. In other implementations, the plating bath is an electroless plating bath and the plating process is an electroless plating process in which the copper metal again nucleates directly on the copper seed layer.

Finally, a chemical mechanical polishing (CMP) process may be used to planarize the deposited copper metal and finalize the copper interconnect structure (214). CMP is well known in the art and generally involves the use of a rotating polishing pad and an abrasive, corrosive slurry on a semiconductor wafer. After a material, such as the copper metal, is deposited on the surface of a semiconductor wafer, the polishing pad and the slurry physically grind flat the microscopic topographic features until the material is planarized, thereby allowing subsequent processes to begin on a flat surface. In many cases the material is further polished by the polishing pad until the material is reduced to a predetermined thickness or until a layer of another material is exposed. Chemical reactions that take place between the slurry and the wafer surface further contribute to the planarizing process.

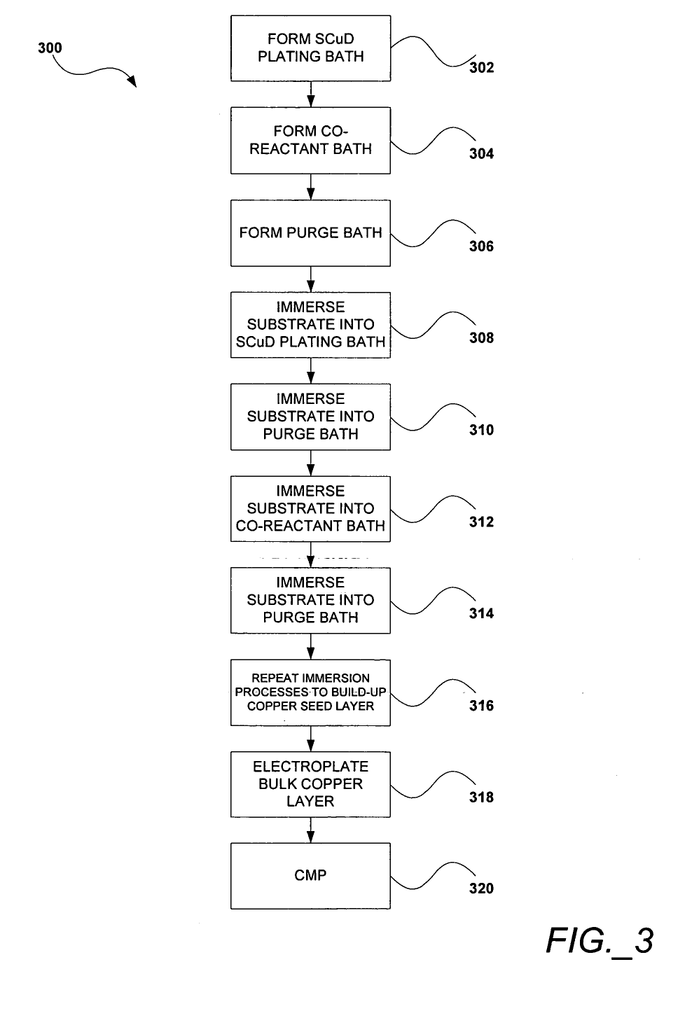

FIG. 3 is a method 300 for carrying out a SCuD process in accordance with another implementation of the invention. Similar to an atomic layer deposition process, the method 300 is a circular and repetitive process with self limiting growth that stacks multiple half-reactions on top of one another. Unlike an atomic layer deposition process, however, the SCuD process occurs in a liquid state rather than a gas state.

Similar to the method 200 above, the method 300 includes forming a SCuD plating bath by providing an organic solvent and dissolving a copper precursor into the organic solvent (302). As noted above, in various implementations of the invention, the organic solvent may be toluene, acetone, acrylamide, benzene, carbon disulfide, ethylene oxide, n-hexane, hydrogen sulfide, methane, methyl mercaptan, methyl-N-butyl ketone, methylene chloride, organochlorine, organophosphates, perchloroethene, styrene, methyl chloroform, trichloroethene, vinyl chloride, xylene, mesitylene, hexanes, decane, octance, nonane, diethylether, tetrahydrofuran, and xylene or another suitable organic solvent.

The copper precursor that is dissolved into the organic solvent may be chosen from among a variety of potential copper precursors. A list of potential copper precursors that may be used in implementations of the invention is provided below. The amount of copper precursor added to the organic solvent will vary based on the needs of a specific interconnect fabrication process, but in some implementations of the invention, the copper precursor concentration in the organic solvent may range between around 0.001 M to 0.1 M.

The method 300 further includes forming a co-reactant bath by providing an organic solvent and dissolving a co-reactant into the organic solvent (304). The organic solvent may be any of the organic solvents listed above, and in some implementations, it may be the same organic solvent that is used to form the SCuD plating bath. The co-reactant that is dissolved into the organic solvent may be selected from a list of potential co-reactants that include, but are not limited to, borane 4-methylmorpholine and other BH3 derivatives, boranes of structure H-BX2 including pinacolborane, silanes including though not limited to diethylsilane, amines including though not limited to tertbutylamine, etc. The amount of co-reactant added to the organic solvent will vary based on the needs of a specific interconnect fabrication process, but in some implementations of the invention, the co-reactant concentration may range between around 0.001 M to 0.1 M.

The method 300 also includes forming a purge bath by simply providing an organic solvent (306). The organic solvent may be any one of the organic solvents listed above, and in some implementations, it may be the same organic solvent that is used to form the SCuD plating bath and/or the co-reactant bath.

With the baths prepared, a substrate that includes a dielectric layer with a trench formed therein is immersed in the SCuD plating bath (308). The substrate and the dielectric layer may be formed using the materials described above. The substrate is immersed for a time duration that is between around 10 seconds and around 3600 seconds. During the immersion in the SCuD plating bath, the copper precursor is adsorbed onto a surface of the substrate. The copper precursor adsorption occurs in a self-limited fashion on the surface of the substrate.

After the copper precursor is adsorbed, the substrate is removed from the SCuD plating bath and is immersed in the purge bath (310). In the purge bath, excess copper precursor is removed or washed away. The substrate may remained immersed in the purge bath for a time duration that is between around 0.5 seconds and around 20 seconds.

The substrate is then removed from the purge bath and is immersed in the co-reactant bath (312). During the immersion in the co-reactant bath, the co-reactant reduces or decomposes the adsorbed copper precursor to form copper metal, thereby causing a layer of copper metal to become deposited on the substrate surface. In various implementations, the substrate may be immersed in the co-reactant bath for a time duration that is between around 5 seconds and around 3600 seconds.

After the layer of copper metal is deposited, the substrate is removed from the co-reactant bath and is again immersed in the purge bath (314). In the purge bath, excess co-reactant and other by-products of the reduction reaction are removed or washed away. The substrate may remained immersed in the purge bath for a time duration that is between around 0.5 seconds and around 20 seconds.

The above processes result in the deposition of a thin layer of copper metal on the substrate, which functions as a copper seed layer. The immersion processes (i.e., processes 308 through 314) may now be repeated one or more times to increase the thickness of the deposited copper metal layer (316). In various implementations, the above process cycles are repeated until the copper seed layer reaches a desired thickness.

Finally, an electroplating process may be used to fill the trench with copper metal to form a copper interconnect (318) and a CMP process may be used to planarize the excess metal (320). The end result is a copper interconnect formed using a SCuD process.

In an alternate implementation of the invention, a combination of the above methods 200 and 300 may be used to form a copper seed layer. For instance, the method 300 may implement a heated SCuD plating bath in addition to using a co-reactant bath.

In another alternate implementation, the method 300 may be carried out by applying the baths to the substrate rather than immersing the substrate in the baths. In some implementations, the application of the baths to the substrate may be performed using a spray technique. For example, a method 400 begins by providing a semiconductor substrate that includes a dielectric layer and a trench formed therein (402). Next, a SCuD plating bath is sprayed onto the substrate (404). The SCuD plating bath spray application may continue for a time, and may be followed by a solvent rinse that is also sprayed onto the substrate (406). The solvent rinse may consist of an organic solvent, such as the solvent used in the SCuD plating bath. Next, a co-reactant bath may be sprayed onto the substrate (408), and after this co-reactant spray continues for a time, another solvent rinse may be applied (410). This spray cycle may be repeated (412) until the copper seed layer that is formed reaches a desired thickness. An electroplating process (414) and a CMP process (416) may follow to complete fabrication of a copper interconnect.

In accordance with implementations of the invention, copper precursors that may be used in any or all of the above described implementations include, but are not limited to, Cu-amidinates such as bis(N,N′-diisopropylacetamidinato)copper(I) and bis(N,N′-disecbutylacetamidinato)copper(I), CpCu(CNMe), CpCu(CNCMe₃), CP*CuCO, CpCuPR₃ (R=Et or Ph), CpCu(CSiMe₃)₂, the alkyl or aryl compounds MeCu(PPh₃)₃, CuMe, CuCCH (ethynylcopper), CuCMe₃ (methylacetylidecopper), (H₂C═CMeCC)Cu (3-methyl-3-buten-1-ynylcopper), (MCH₂CH₂CC)Cu (1-pentynylcopper), CuCCPh, C₆H₅Cu (phenyl copper), (Me)₃CCCCu (3,3-dimethyl-1-butynyl) copper, (H₃CCH═CH)₂CuLi, Me₃SiCCCH₂Cu, and other compounds such as CuCN, [Cu(OAc]n, Cu₂Cl₂(butadiene), μ-[(trimethylsilyl)methyl]copper, C₇H₇CuO(2-methoxyphenylcopper), ([COD]CuCl)₂, (MeCN)₄Cu⁺, Me₃SiOCu(PMe₃)₃, CU(C₄H₄S), aryloxycopper(I) complexes, aminopyridine-copper(I) complexes, N-(isopropyl)salicyliminato copper(I), and Cu-carbene compounds (e.g. those that are imidazolium derived). In alternate implementations, copper precursors not listed here but that are sufficient for use in a SCuD process as described herein may be used.

In various implementations of the invention, copper seed layers produced using the SCuD process described herein are relatively thinner than conventionally formed copper seed layers (i.e., copper seed layers formed using a physical vapor deposition process, a chemical vapor deposition process, an atomic layer deposition process, an electroplating process, or an electroless plating process). For instance, conventionally formed copper seed layers may range in thickness from 20 nm to 60 nm, while copper seed layers formed in accordance with implementations of the invention may range from 3 nm to 20 nm.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
applying a non-aqueous SCuD plating bath to a surface of a substrate;
rinsing the surface;
applying a non-aqueous co-reactant bath to the surface; and
rinsing the surface.

2. The method of claim 1, wherein the applying of the SCuD plating bath comprises immersing the substrate in the SCuD plating bath.

3. The method of claim 1, wherein the applying of the co-reactant bath comprises immersing the substrate in the co-reactant bath.

4. The method of claim 1, wherein the applying of the SCuD plating bath comprises spraying the SCuD plating bath onto the surface of the substrate.

5. The method of claim 1, wherein the applying of the co-reactant bath comprises spraying the co-reactant bath onto the surface of the substrate.

6. The method of claim 1, wherein the SCuD plating bath comprises a copper precursor dissolved in an organic solvent.

7. The method of claim 6, wherein the copper precursor comprises at least one of bis(N,N′-diisopropylacetamidinato)copper(I), bis(N,N′-disecbutylacetamidinato)copper(I), CpCu(CNMe), CpCu(CNCMe₃), CP*CuCO, CpCuPR₃ (R=Et or Ph), CpCu(CSiMe₃)₂, MeCu(PPh₃)₃, CuMe, CuCCH (ethynylcopper), CuCMe₃ (methylacetylidecopper), (H₂C═CMeCC)Cu (3-methyl-3-buten-1-ynylcopper), (MCH₂CH₂CC)Cu (1-pentynylcopper), CuCCPh, C₆H₅Cu (phenyl copper), (Me)₃CCCCu (3,3-dimethyl-1-butynyl) copper, (H₃CCH═CH)₂CuLi, Me₃SiCCCH₂Cu, CuCN, [Cu(OAc]n, Cu₂Cl₂(butadiene), p-[(trimethylsilyl)methyl]copper, C₇H₇CuO(2-methoxyphenylcopper), ([COD]CuCl)₂, (MeCN)₄Cu⁺, Me₃SiOCu(PMe₃)₃, Cu(C₄H₄S), aryloxycopper(I) complexes, aminopyridine-copper(I) complexes, N-(isopropyl)salicyliminato copper(I), and imidazolium derived Cu-carbene compounds.

8. The method of claim 6, wherein the organic solvent comprises at least one of toluene, acetone, acrylamide, benzene, carbon disulfide, ethylene oxide, n-hexane, hydrogen sulfide, methane, methyl mercaptan, methyl-N-butyl ketone, methylene chloride, organochlorine, organophosphates, perchloroethene, styrene, methyl chloroform, trichloroethene, vinyl chloride, mesitylene, hexanes, decane, octane, nonane, diethylether, tetrahydrofuran, and xylene.

9. The method of claim 1, wherein the co-reactant bath comprises a co-reactant dissolved in an organic solvent.

10. The method of claim 9, wherein the co-reactant comprises at least one of borane 4-methylmorpholine, boranes of structure H-BX₂, pinacolborane, silanes, diethylsilane, amines, and tertbutylamine.

11. The method of claim 9, wherein the organic solvent comprises at least one of toluene, acetone, acrylamide, benzene, carbon disulfide, ethylene oxide, n-hexane, hydrogen sulfide, methane, methyl mercaptan, methyl-N-butyl ketone, methylene chloride, organochlorine, organophosphates, perchloroethene, styrene, methyl chloroform, trichloroethene, vinyl chloride, mesitylene, hexanes, decane, octane, nonane, diethylether, tetrahydrofuran, and xylene.

12. The method of claim 1, wherein the surface is rinsed with an organic solvent.

13. A method comprising:
heating a non-aqueous SCuD plating bath; and
immersing a substrate into the SCuD plating bath until a copper seed layer is deposited.

14. The method of claim 13, wherein the SCuD plating bath is heated to a temperature between around 25° C. and around 100° C.

15. The method of claim 13, wherein the substrate is immersed for a time duration between around 2 seconds and around 3600 seconds.

16. The method of claim 13, wherein the SCuD plating bath comprises a copper precursor dissolved in an organic solvent.

17. The method of claim 16, wherein the SCuD plating bath further comprises a radical initiator.

18. The method of claim 17, wherein the radical initiator is selected from the group consisting of 2,2,6,6-tetramethylpiperidine-N-oxyl and benzoyl peroxide.

19. The method of claim 13, further comprising:
providing an organic solvent; and
dissolving a copper precursor into the organic solvent to form the non-aqueous SCuD plating bath.

20. The method of claim 19, further comprising dissolving a radical initiator into the organic solvent, wherein the radical initiator is selected from the group consisting of 2,2,6,6-tetramethylpiperidine-N-oxyl and benzoyl peroxide.

21. A plating bath to deposit copper onto a substrate comprising:
an organic solvent; and
a copper precursor.

22. The plating bath of claim 21, wherein the organic solvent comprises at least one of toluene, acetone, acrylamide, benzene, carbon disulfide, ethylene oxide, n-hexane, hydrogen sulfide, methane, methyl mercaptan, methyl-N-butyl ketone, methylene chloride, organochlorine, organophosphates, perchloroethene, styrene, methyl chloroform, trichloroethene, vinyl chloride, mesitylene, hexanes, decane, octane, nonane, diethylether, tetrahydrofuran, and xylene.

23. The plating bath of claim 21, wherein the copper precursor comprises at least one of bis(N,N′-diisopropylacetamidinato)copper(I), bis(N,N′-disecbutylacetamidinato)copper(I), CpCu(CNMe), CpCu(CNCMe₃), Cp*CUCO, CpCuPR₃ (R=Et or Ph), CpCu(CSiMe₃)₂, MeCu(PPh₃)₃, CuMe, CuCCH (ethynylcopper), CuCMe₃ (methylacetylidecopper), (H₂C═CMeCC)Cu (3-methyl-3-buten-1-ynylcopper), (MCH₂CH₂CC)CU (1-pentynylcopper), CuCCPh, C₆HsCU (phenyl copper), (Me)₃CCCCU (3,3-dimethyl-1-butynyl) copper, (H₃CCH═CH)₂CuLi, Me₃SiCCCH₂CU, CuCN, [Cu(OAc]n, Cu₂Cl₂(butadiene), μ-[(trimethylsilyl)methyl]copper, C₇H₇CuO(2-methoxyphenylcopper), ([COD]CUCl)₂, (MeCN)₄Cu+, Me₃SiOCU(PMe₃)₃, Cu(C₄H₄S), aryloxycopper(I) complexes, aminopyridine-copper(I) complexes, N-(isopropyl)salicyliminato copper(I), and imidazolium derived Cu-carbene compounds.

24. The plating bath of claim 21, wherein a molarity of the copper precursor in the organic solvent is between around 0.001M and around 0.1M.

25. The plating bath of claim 21, further comprising a radical initiator.

26. The plating bath of claim 25, wherein the radical initiator is selected from the group consisting of 2,2,6,6-tetramethylpiperidine-N-oxyl and benzoyl peroxide.
